(19) United States
(12) Patent Application Publication
(10) Pub. No.: US 2018/0004550 A1
(43) Pub. Date: Jan. 4, 2018

(54) DEVICE INTEGRATION PLATFORM SYSTEMS AND METHODS

(71) Applicant: Intertrust Technologies Corporation, Sunnyvale, CA (US)

(72) Inventor: Jarl NILSSON, Mountain View, CA (US)

(73) Assignee: Intertrust Technologies Corporation, Sunnyvale, CA (US)

(21) Appl. No.: 15/634,337

(22) Filed: Jun. 27, 2017

Related U.S. Application Data
(60) Provisional application No. 62/357,849, filed on Jul. 1, 2016.

(51) Int. Cl. G06F 9/445; G06E 1/02; G06D 1/08

(52) U.S. Cl. CPC G06F 9/44505; G06D 1/08; G06E 1/02

(57) ABSTRACT

This disclosure relates to a platform for integrating a variety of devices. The platform may provide a plurality of contact points configured to couple with one or more interfaces on a device and/or termination points of various connectors. Embodiments of the disclosed platform may facilitate construction and/or prototyping of chemical and/or biological analysis and/or diagnostic systems that include multiple devices. Further embodiments, allow for the management of various interconnected devices in accordance with one or more articulated policies.

### RELATED APPLICATIONS

This application claims the benefit of priority under 35 U.S.C. §119(e) to U.S. Provisional Application No. 62/357,849, filed Jul. 1, 2016, and entitled “ANALYSIS AND DIAGNOSTIC PLATFORM SYSTEMS AND METHODS,” which is hereby incorporated by reference in its entirety.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### SUMMARY

The present disclosure relates generally to device integration systems and methods. More specifically, but not exclusively, the present disclosure relates to a platform for integrating one or more lab-on-a-chip (“LOC”) devices to facilitate a variety of analysis and/or diagnostic methods.

LOC devices may be used in connection with a wide variety of chemical and/or biological analysis and/or diagnostic methods. LOC technology may allow for integration of multiple chemical and/or biological laboratory functions on a single chip of a relatively small size. Among other benefits, miniaturization of multiple laboratory functions using LOC technology may allow for chemical and/or biological analysis methods and diagnostics that are faster, less expensive, and/or easier to integrate in a variety of devices than conventional laboratory techniques.

System and methods disclosed herein relate to a platform for integrating one or more LOC devices. Certain embodiments of the disclosed platform may be used to prototype integrated systems that include a variety of LOC devices. In certain embodiments, the platform may provide a plurality of contact points configured to couple with one or more interfaces on a LOC device and/or termination points of various connectors. The contact points may allow for LOC devices to be secured to the platform and interconnection of the LOC devices with one or more connectors. In this manner, embodiments of the disclosed platform may facilitate construction and/or prototyping of chemical and/or biological analysis and/or diagnostic integrated systems that include multiple LOC devices.

Further embodiments of the disclosed systems and methods allow for managing various interconnected LOC devices. For example, in some circumstances, it may be desirable to prevent certain chemical and/or biological processes from being performed by various interconnected LOC devices, such as the synthesis of neurotoxins, the generation of explosive substances, and/or the production of gaseous carcinogens. Consistent with various disclosed embodiments, policies may be enforced in connection with the interconnection and/or operation of LOC devices using the disclosed integration platform to ensure the devices interconnect and/or operate in a permitted manner. In some embodiments, policies may be enforced using various physical control structures associated with the interconnecting LOC devices and/or associated connections or contact points. In further embodiments, policies may be enforced via one or more electronic control mechanisms implemented by one or more electronic control units included in and/or otherwise associated with the device integration platform.

### BRIEF DESCRIPTION OF THE DRAWINGS

The inventive body of work will be readily understood by referring to the following detailed description in conjunction with the accompanying drawings, in which:

FIG. 1 illustrates simplified example of a device integration platform consistent with embodiments of the present disclosure.

FIG. 2 illustrates another example of a device integration platform consistent with embodiments of the present disclosure.

FIG. 3 illustrates examples of physical policy control interconnection structures consistent with the embodiments of the present disclosure.

FIG. 4 illustrates policy management using a device integration platform consistent with embodiments of the present disclosure.

FIG. 5 illustrates a flow chart of an exemplary method of enforcing policy using a device integration platform consistent with embodiments disclosed herein.

FIG. 6 illustrates an exemplary system that may be used to implement various embodiments of the systems and methods of the present disclosure

### DETAILED DESCRIPTION

A detailed description of the systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to the drawings, wherein like parts may be designated by like numerals or descriptions. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure but is merely representative of possible embodiments of the disclosure. In addition, the steps of any method disclosed herein do not necessarily need to be executed in any specific order, or even sequentially, nor need the steps be executed only once, unless otherwise specified.

LOC devices, which may be generally referred to herein as devices, may be used in connection with a wide variety of chemical and/or biological analysis, testing, diagnostic, and/or prototyping methods. Consistent with disclosed embodiments, a LOC device may incorporate features used to perform various chemical and/or biological processes including, without limitation, sampling, transporting, filtration, dilution, chemical reactions, separation, detection, polymerase chain reaction (“PCR”), detection of bacteria, viruses, and/or cancers, biochemical assays, immunoassays, dielectrophoresis processes, oxidization, filtration, ion channel screening processes, allergen testing, genetic testing and/or analysis, and/or the like. LOC devices may incorporate a variety of technologies including, for example, microfluidics, optical waveguides and/or other optical structures, micro-electro mechanical systems, sensor systems, mechanical systems, and/or electrical systems. It will be appreciated that a variety of LOC devices configured to perform a variety of processes may be utilized in connection with the disclosed systems and methods, and that any suitable LOC devices may be used in connection with the disclosed embodiments.

Embodiments disclosed herein provide for a platform that allows for integration of one or more LOC devices. In some embodiments, the platform may comprise a prototyping platform allowing for construction of an integrated system that incorporates multiple devices interconnected using one or more connectors that may be integral to and/or separate from the integration platform. LOC device interfaces may be physically secured to the platform via one or more contact points. These contact points may be associated with one or more interconnections allowing interfaces of the LOC devices to be coupled with one or more connectors. Consistent with embodiments disclosed herein, connectors and/or associated contact points may allow for mechanical, electrical, microfluidic, and/or optical interconnection between LOC device interfaces and/or systems and/or devices external to and/or integrated within the platform.

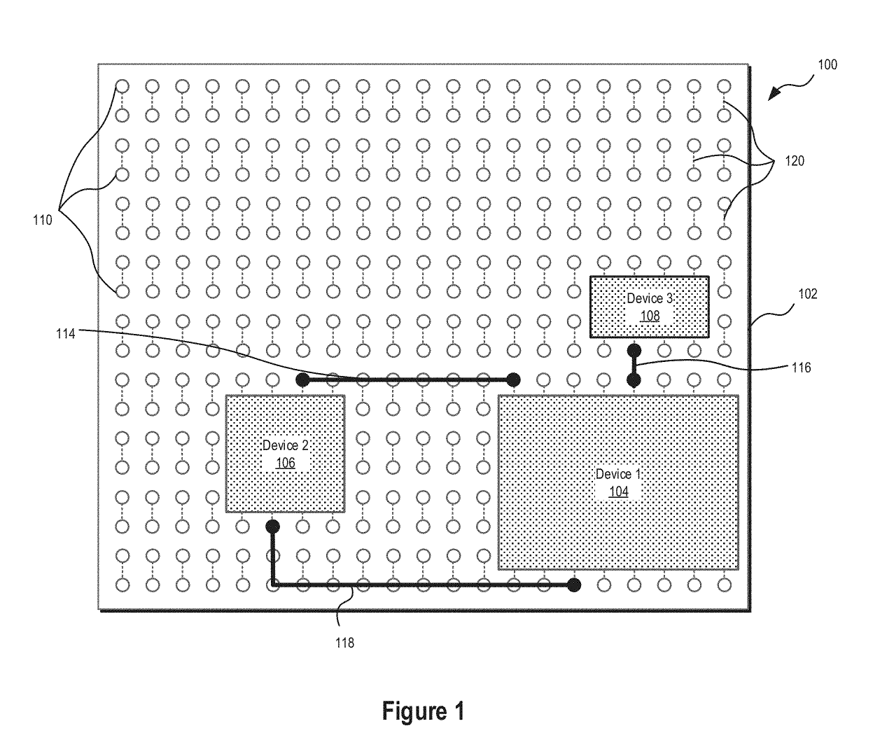

FIG. 1 illustrates a simplified example of a device integration platform 100 consistent with embodiments of the present disclosure. In certain embodiments, the platform may include a structural substrate 102. The substrate 102 may comprise any suitable material including, without limitation, plastic, metal, and/or the like. In certain embodiments, the substrate 102 may comprise a material that is relatively inert, non-conductive, and/or the like. The substrate 102 may further include areas comprising different materials. For example, a first portion of the substrate 102 may comprise a non-conductive plastic and a second portion of the substrate 102 may comprise an inert and/or non-reactive conductive metal material.

A plurality of contact points 110 may be defined in the substrate 102. In certain embodiments, the contact points 110 may be configured to couple with one or more device interfaces of various LOC devices 104-108 and/or terminations of connectors 114-118. In certain embodiments, the contact points 110 may be configured to physically secure the LOC devices 104-108 and/or connectors 114-118 to the substrate via any suitable mechanism (e.g., compression fit, spring mechanism, a clip mechanism, etc.). Contact points 110 may comprise, without limitation, one or more of mechanical contact points, electrical contact points, microfluidic contact points, optical contact points, and/or the like.

In certain embodiments, one or more contact points 110 may be configured to provide a variety of functions. For example, a contact point 110 may be configured to both mechanically secure as well as electrically connect a LOC device 104-108 and/or a connector 114-118. Similarly, a contact point 110 may be configured to both mechanically secure as well as fluidically connect a LOC device 104-108 and/or a connector 114-118. In further embodiments, contact points 110 may provide a single function, such as mechanical connection, electrical connection, fluidic connection, optical connection, and/or the like.

In some embodiments, a LOC device 104-108 may interconnect with a plurality of contact points 110, and may further be configured to connect with contact points 110 of various types. A LOC device 104-108 may comprise multiple interfaces configured to interface with multiple contact points 110 and/or types of contact points 110. For example, a LOC device 104-108 may include a mechanical interface, an optical interface, and a fluidic interface that may be configured to connect with complementary contact points 110 of the device integration platform 100.

Certain contact points 110 may be interconnected via one or more associated contact point interconnections 120. The contact point interconnections 120 may comprise, without limitation, electrical interconnections, fluidic interconnections (e.g., microfluidic channels), and/or optical interconnections (e.g., optical waveguides, fiber connections, etc.). In certain embodiments, the contact point interconnections 120 may allow for interconnection between interfaces associated with LOC devices 104-108 and/or connectors 114-118 coupled to associated contact points 110. The connectors 114-118 may comprise any suitable type of connector including, for example, optical connectors (e.g., optical fiber), electrical connectors (e.g., jump wires), and/or microfluidic connectors (e.g., microfluidic tubing). For example, a microfluidic outlet interface of a first LOC device may be connected to a microfluidic inlet interface of a second LOC device via microfluidic contact points 110 and an associated microfluidic contact point interconnection 120 between the contact points. Similarly, an optical connector (e.g., an optical fiber and/or the like) coupled to an external laser system may be coupled to an optical input interface of a LOC device via optical contact points 110 and an associated optical contact point interconnection 120 between the contact points 110.

In certain embodiments, the contact points 110, interfaces associated with LOC devices 104-108, and/or terminations of connectors 114-118 may comprise any suitable type of interfaces. For example, the interfaces may comprise snap, screw, clip, and/or any other suitable type of connector interface. In further embodiments, the contact points 110, interfaces associated with LOC devices 104-108, and/or terminations of connectors 114-118 may comprise one or more standardized interfaces. For example, the contact points 110, interfaces associated with LOC devices 104-108, and/or terminations of connectors 114-118 may comprise one or more male or female Leur Lock microfluidic connectors, CapTite microfluidic connectors, Nanoport microfluidic connectors, standardized threaded microfluidic connectors, and/or the like. Similarly, the contact points 110, interfaces associated with LOC devices 104-108, and/or terminations of connectors 114-118 may comprise one or more male or female ST optical connectors, SC optical connectors, FC optical connectors, LC optical connectors, MPO optical connectors, ESCON optical connectors, MTRJ optical connectors, VF45 optical connectors, and/or the like.

In certain embodiments, contact point interconnections 120 may be integral to the platform substrate 102. For example, in some embodiments, the contact point interconnections 120 may comprise microfluidic channels, optical waveguides, and/or the like defined within and/or otherwise integral to the structure of the platform substrate 120. In further embodiments, the contact point interconnections 120 may comprise separate and/or otherwise discrete components disposed on and/or embedded within the platform substrate 102. For example, contact point interconnections 120 may comprise a discrete optical fiber, an electrical trace, and/or a microfluidic channel embedded within the platform substrate.

In some embodiments, interfaces of LOC devices 104-108 and/or terminations of connectors 114-118 may be configured to be removably and/or otherwise temporarily coupled with the platform contact points 110. For example, as discussed above, the contact points 110 may comprise snap, screw, and/or clip connections that may be selectively coupled and/or removed from terminations of connectors 114-118 and/or LOC device interfaces. In further embodiments, LOC device interfaces and/or terminations of connectors 114-118 may be configured to be permanently and/or semi-permanently coupled and/or affixed to platform contact points 110. For example, in some embodiments, LOC device interfaces and/or terminations of connectors 114-118 may be soldered, wire wrapped, adhesively bonded, and/or the like to platform contact points 110.

In further embodiments, certain contact points 110 and/or associated contact point interconnections 120 may comprise one or more types of contact point strips that may include, for example, terminal strips and/or bus strips. Terminal strips may be configured to couple with various LOC devices 104-108 and/or associated connectors 114-118. Bus strips may be configured to supply various LOC devices 104-108 with inputs shared by multiple LOC devices 104-108 (e.g., supply voltages, pump outputs, reservoirs such as reagent reservoirs, etc.). In some embodiments, bus strips may be located one or more sides of the device integration platform 100.

Any suitable number of contact points 110 may be connected via associated contact point interconnections 120 in any suitable configuration. For example, in some embodiments, more than two contact points 110 may be coupled with associated contact point interconnections 120 forming contact point strips across an entirety and/or a portion of the integration platform 100. That is, a plurality of contact points 110 may be coupled by one or more associated interconnections 120. In further embodiments, some contact points 110 may not be interconnected with other contact points 110. For example, a contact point 110 may comprise a mechanical contact point configured to physically secure and/or otherwise retain an LOC device 104-108 to the platform 100 rather than interconnect the device 104-108 with one or more other devices 104-108 and/or connectors 114-118. It will be appreciated that a variety of configurations of contact points 110 may be used in connection with the disclosed embodiments, and that any suitable configuration may be used in connection with embodiments of the disclosed platform 100.

In certain embodiments, different areas and/or portions of the integration platform 100 may comprise different types of contact points 110 and/or contact point interconnections 120. For example, in some embodiments, a first portion of the integration platform 100 may comprise contact points 110 and/or associated interconnections 120 that facilitate microfluidic interconnection with fluidic interfaces of devices 104-108 and/or connectors 114-118, a second portion may comprise contact points 110 and/or associated interconnections 120 that facilitate optical interconnection with optical interfaces of devices 104-108 and/or connectors 114-118, and a third portion may comprise contact points 110 and/or associated interconnections 120 that facilitate electrical interconnection with electrical interfaces of device 104-108 and/or connectors 114-118. In this manner, the platform may be used to build integrated systems comprising a variety of different types of LOC devices 104-108 and/or connectors 114-118 to perform a variety of chemical and/or biological analysis and/or diagnostic methods.

In some embodiments, the integrations platform 100 may comprise one or more clips and/or other mechanical mechanisms allowing for a plurality of platforms 100 to be connected, thereby resulting in a larger integration platform. In certain embodiments, this may allow for subsystems to be built on separate individual platforms 100 then integrated on a single larger platform by connecting the platforms 100 and associated subsystems via contact points 110 and associated interconnections 120.

It will be appreciated that a number of variations can be made to the architecture, relationships, and examples presented in connection with FIG. 1 within the scope of the inventive body of work. For example, as discussed in more detail below, the device integration platform 100 may further include a variety of other devices and/or structures configured to facilitate the integration and/or operation of the devices 104-108 (e.g., pumps, reservoirs, microcontrollers, etc.). Thus it will be appreciated that the architecture, relationships, and examples presented in connection with FIG. 1 are provided for purposes of illustration and explanation, and not limitation.

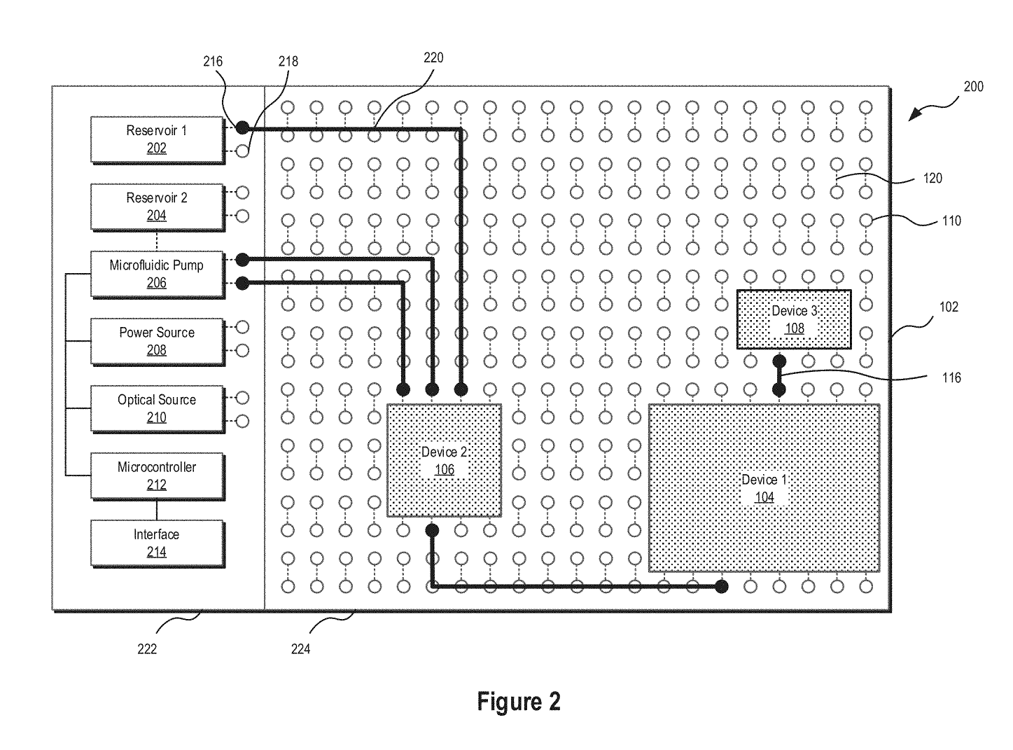

FIG. 2 illustrates another example of a device integration platform 200 consistent with embodiments of the present disclosure. In certain embodiments, the disclosed integration platform 200 may further include one or more devices 202-214 integrated within and/or otherwise associated with the platform 200. For example, as illustrated, the integration platform 200 may comprise one or more integrated microfluidic reservoirs 202, 204 (e.g., reagent reservoirs and/or the like), one or more microfluidic pumps 206, one or more electrical power sources 208, and/or one or more optical sources 210 (e.g., a laser source and/or the like).

The devices 202-214 integrated within and/or otherwise associated with the integration platform 200 may be interconnected in a variety of ways to enable various operations using the platform 200. For example, the electrical power source 208 may be coupled to the one or more optical sources 210 and/or the microfluidic pumps 206 and be configured to provide electrical power in connection with their operation. Similarly, the electrical power source 208 may be coupled to provide power to one or more LOC devices 104-108 associated with the platform 200.

One or more microcontrollers 212 and/or any other suitable control system and/or processing device may be communicatively coupled to one or devices 202-210, 214 integrated within and/or otherwise associated with the platform 200. In certain embodiments, the microcontroller 212 may be configured to monitor and/or control the operation of various communicatively coupled devices 202-210, 214, 104-108. For example, as illustrated, the microcontroller 212 may be communicatively coupled to the microfluidic pump 206, the power source 208, and/or the optical source 210 of the device integration platform 200 and be configured to monitor and/or control the operation of the devices 206-210.

In further embodiments, one or more of the LOC devices 104-108 secured to the device integration platform 100 may be communicatively coupled and monitored, and/or controlled by the microcontroller 212. Although a single microcontroller 212 is illustrated in connection with FIG. 2, it will be appreciated that in further embodiments, a plurality of microcontrollers 212 may be used.

In certain embodiments, a user may be able to interact with the microcontroller 212 and/or associated devices via an interface 214. In some embodiments, the interface 214 may allow a user to directly interface with the microcontroller 212 to control and/or otherwise monitor the microcontroller 212 and/or associated communicatively coupled devices (e.g., devices 202-210, 214, 104-108). In further embodiments, a user may couple another system (e.g., a computer system and/or the like) to the interface 214 to monitor and/or control the microcontroller 212 and/or associated devices. For example, the interface 214 may comprise one or more data ports enabling communication with and/or control of the microcontroller 212.

In some embodiments, various devices 202-214 and/or components thereof may be integrated within the platform 120 (e.g., integrated at a time of manufacture and/or the like). For example, the microfluidic reservoirs 202, 204 may be defined within and/or otherwise be integral to the structure of the platform substrate 102. In further embodiments, certain aspects of the devices 202-214 may be integrated within the platform 200. For example, certain components of the microfluidic pump 206 may be fabricated as part of the substrate 102 (e.g., via microelectromechanical systems fabrication techniques and/or the like), while other components may be fabricated separately.

In further embodiments, various devices 202-214 and/or components thereof may comprise discrete components separate from the platform 200 that may be included on the platform 200 at a time of manufacture and/or at a later time by a user. For example, discrete microcontrollers 212, optical sources 210, power sources 208, and/or microfluidic pumps 206 may be separate components that are configured to be operatively coupled with the device integration platform 200. In this manner, various devices 204-214 included on the platform 200 may be customized to suit user needs. In addition, this may allow for certain reusable, relatively expensive, and/or relatively easy to clean devices 202-214 to be reused in connection with other device integration platforms 200.

In various embodiments, the devices 202-214 and/or a subset thereof may be included in a separate portion 222 of the platform 200 than the portion 224 that includes the contact points 110 for integrating the LOC devices 104-108. For example, a first portion 222 of the platform 200 may be configured to be detachable from a second portion 224 of the platform 200 comprising the contact points 110. In this manner, the first portion 222 of the platform and/or certain associated integrated devices 202-214 may be reused.

The devices 202-214 may include various terminals for interfacing with the contact points 110 of the integration platform 200 and/or various LOC devices 104-108. For example, the electrical power source 208 may include one or more power supply terminals (e.g., positive and negative electrical contact terminals and/or the like). Similarly, the optical source 210 may comprise one or more optical output terminals.

In some embodiments, one or more of the devices 202-214 may include a plurality of terminals. In some embodiments, the terminals may be the same and/or otherwise be duplicative. In further embodiments, the terminals may be different. For example, the power source 208 may include a plurality of output power supply terminals at different voltages and/or the like. Similarly, the optical source 210 may comprise a plurality of optical output terminals at differing output wavelengths and/or optical energies.

Various terminals of devices 202-214 may comprise inlet and/or outlet terminals. For example, a microfluidic reservoir 202 may comprise an inlet terminal 218 and/or an outlet terminal 216. Similarly, a microfluidic pump 206 may comprise an inlet terminal and/or an outlet terminal.

In certain embodiments, one or more terminals of devices 202-214 may be associated with one or more terminal strips and/or bus strips. In some embodiments, the terminal and/or bus strips may be configured to connect various LOC devices 104-108 to contacts shared with the devices 202-214.

In the illustrated example, a microfluidic pump 206 may be coupled via an outlet terminal and an inlet terminal to a LOC device 106 via associated microfluidic connectors. The device 106 may be further coupled to an outlet and/or supply terminal 216 of a reservoir 202 to receive a reagent. In some embodiments, the reagent from the reservoir 202 may be delivered to the device 106 by the microfluidic pump 206. In further embodiments, a reagent from a second reservoir 204, which may be fluidically coupled to the pump 206 via an associated interconnection, may be further delivered to the device 106. Various operations of the device 106 and/or the microfluidic pump may be controlled by a microcontroller 212 associated with the integration platform 200. The device 106 may further operate in connection with coupled devices 104, 108 to perform a desired biochemical process.

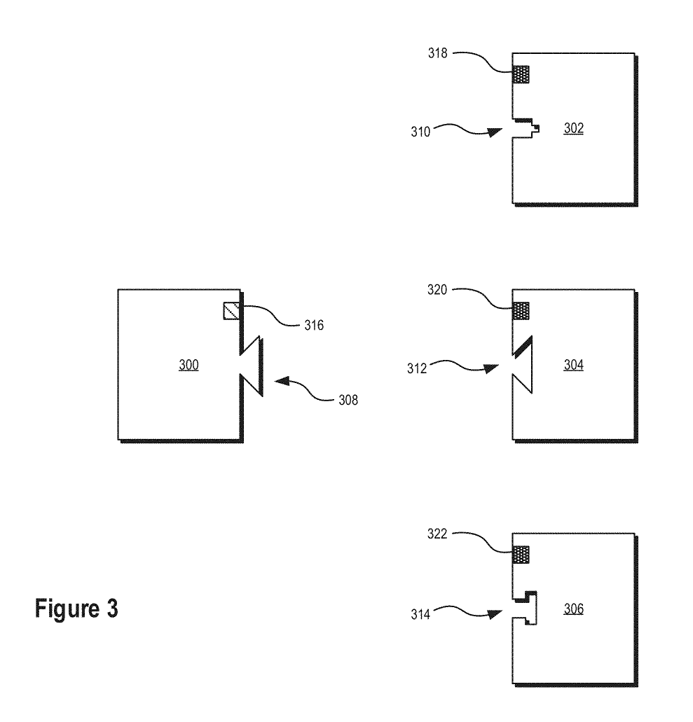

FIG. 3 illustrates examples of physical policy control interconnection structures 308-314 consistent with the embodiments of the present disclosure. In certain embodiments, the configuration, integration, and/or operation of various interconnected LOC devices may be managed according to one or more policies. For example, it may be desirable to prevent certain chemical and/or biological processes from being performed by various interconnected LOC devices, such as the synthesis of neurotoxins, the generation of explosive substances, and/or the production of gaseous carcinogens. Accordingly, consistent with various disclosed embodiments, policies may be enforced in connection with the interconnection and/or operation of LOC devices using the disclosed integration platform to ensure the devices interconnect and/or operate in a permitted and/or otherwise safe manner.

In some embodiments, policies may be enforced using various physical control structures 308-314 associated with the LOC devices 300-306. Although various illustrated embodiments show physical policy control interconnection structures 308-314 in connection with LOC devices 300-306, it will be appreciated that further embodiments may implement similar control structures 308-314 and/or associated physical control principles in connection with discrete connectors for interconnecting LOC devices 300-306 and/or contact points associated with a device integration platform consistent with the disclosed embodiments.

As shown, LOC devices 300-306 may include associated interfaces 316-322. Certain interconnection of the LOC devices 300-306 may be undesirable. In one example, when an output interface 316 of device 300 is connected with inlet interfaces 318, 322 of devices 302, 306, a harmful substance may be produced by the integrated system. Accordingly, it may be undesirable to allow device 300 to be interconnected with devices 302 or 306.

Consistent with embodiments disclosed herein, a policy may be enforced to prevent the interconnection of device 300 with devices 302, 306 using physical policy control interconnection structures 308-314. For example, the physical structure of policy control structure 308 associated with device 300 may prevent it from being interconnected with the physical control structures 310, 314 associated with devices 302, 306, thereby enforcing the associated policy relating to the interconnection of devices 300, 302, and 306. Similarly, the physical structure of policy control structure 308 associated with device 300 may allow it to be interconnected with the physical control structure 312 of device 304—that is, structures 308 and 312 may be complementary, thereby allowing the interconnection of devices 300, 304 in accordance with associated policy.

In this manner, the interconnection of device 300 with device 304 may be permitted, whereas the interconnection of device 300 with devices 302, 306 may be disallowed. It will be appreciated that a variety of physical control structures may be utilized in connection with the management of the interconnection of devices, connectors, and/or contact points in accordance with associated policy, and that any suitable physical control structure may be used in connection with various disclosed embodiments.

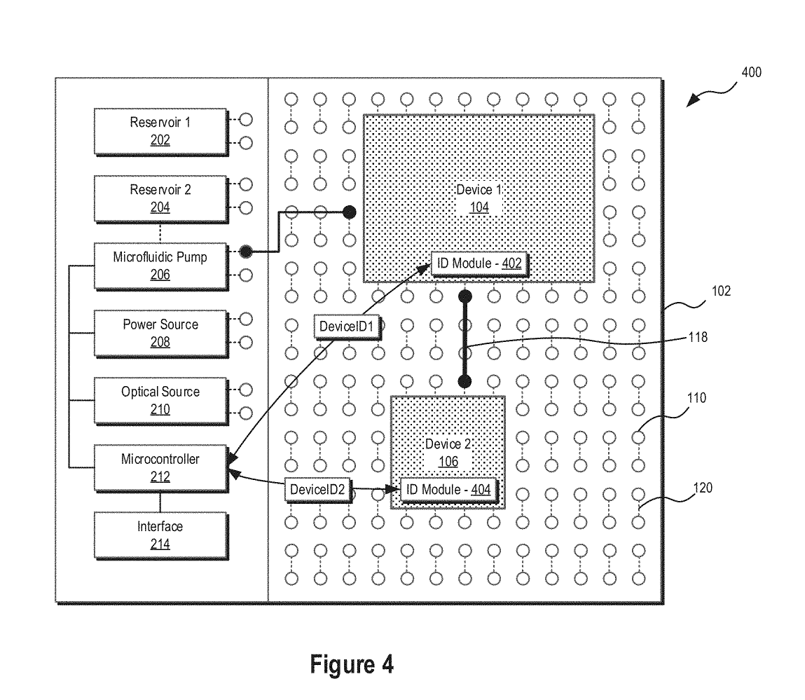

FIG. 4 illustrates policy management using a device integration platform 400 consistent with embodiments of the present disclosure. In certain embodiments, policies relating to the interconnection of LOC devices 104, 106 may be enforced by one or more electronic control mechanisms. For example, one or more electronic control systems included in and/or otherwise associated with the device integration platform 400, such as a microcontroller 212, may be used in connection enforcing policy relating the interconnection of the devices 104, 106 using the device integration platform 400.

In some embodiments, the microcontroller 212 may receive various information relating the types of devices 104, 106 interconnected on the device integration platform 400 and/or information relating to the specific manner in which the devices are interconnected on the platform 400. For example, in some embodiments, devices 104, 106 may include associated ID modules 402, 404. Each ID module 402, 404 may contain information that identifies an associated device 104, 106. In some embodiments, the information may uniquely identify an associated device 104, 106. For example, the information may comprise a serial number of an associated device 104, 106. In further embodiments, the information may not necessarily be unique to a particular device 104, 106, but may provide an indication of a type and/or function of the associated device 104, 106. For example, alternatively and/or in addition to unique identifiers, the information may comprise a model number of an associated device 104, 106, a description of a function and/or operation performed by a device (e.g., oxidation, reduction, hydrogenation, hydrolysis, hydration, dehydration, halogenation, nitrification, sulfonation, ammonization, alkylation, dealkylation, esterification, polymerization, polycondensation, catalyzation, synthesis and/or generation of a particular compound and/or substance, etc.), and/or the like.

In some embodiments, identification information associated with various connectors 118 may be further communicated to the microcontroller 212. The identification information may uniquely identify an associated connector 118 (e.g., a serial number). The identification information may, alternatively or in addition, provide an indication of a type and/or function of the associated connector (e.g., a model number and/or the like).

Identification information may be transmitted to the microcontroller 212 by the devices 104, 106, associated ID modules 402, 404, and/or connectors 118 in a variety of ways. For example, in some embodiments, when a device 104, 106 and/or connectors 118 is coupled to the device integration platform 400 via associated contact points 110, the device 104, 106 and/or connectors 118 may be communicatively coupled with the microcontroller 212 via one or more of the contact points 110 and/or associated interconnections 120. In some embodiments, the one or more contact points 110 may be dedicated contact points 110 providing a communication path between the devices 104, 106 and/or connectors 118 and the microcontroller 212, allowing for the communication of information between the devices 104, 106 and/or connectors 118 and the microcontroller 212. Such information may include, for example, device and/or connector identification information, sensor information, control instructions, and/or the like. In further embodiments, information may be exchanged between the devices 104, 106 and/or the connectors 118 and the microcontroller 212 using one or more shared communication paths, and/or via one or more other wired and/or wireless communication channels (e.g., near-field communication channels and/or the like).

Device and/or connector identification information communicated to the microcontroller 212 may further provide an indication of a manner in which the various devices 104, 106 and/or connectors 118 are interconnected on the device integration platform 400. That is, in addition to information relating to which devices 104, 106 and/or connectors 118 are included on the platform 400, the identification information may further provide a description of the specific configuration of the various devices 104, 106 and/or connectors 118. For example, the device and/or connector identification information may provide location information relating to a location of the devices 104, 106 and/or connectors 118 on the platform 400, information relating to where device interfaces and/or connection terminations are located on the platform, and/or the like.

Device and/or connector identification information communicated to the microcontroller 212 may be used by the microcontroller 212 to generate a map indicating where devices 104, 106 and/or associated connectors 118 are located on the integration platform 400 and/or the manner in which the devices 104, 106 and/or associated connectors 118 are configured. For example, a device interconnection mapping engine executing on the microcontroller 212 may, based on received device and/or connector identification information, determine how various devices 104, 106 and/or connectors 118 included on the device interaction platform 118 are configured.

A policy management engine executing on the microcontroller 212 may compare the generated configuration map with information included in a policy management database to determine whether the integrated system reflected by the map is permitted to operate according to applicable policy. For example, the policy management database may comprise one or more policy managed device configurations and/or associated policy control actions.

If a generated configuration map matches a policy managed device configuration included in the database, the policy management engine may implement the associated policy control actions. For example, the policy management engine may disallow operation of the integrated system of devices 104, 106 and/or only allow operation of the integration systems of devices 104, 106 in a specified manner. It will be appreciated that a variety of types of policies relating to the operation of an integrated system of devices 104, 106 may be enforced by the microcontroller 212, and that any suitable type of policy articulating a variety of conditions and/or control actions may be used in connection with the disclosed embodiments.

In the illustrated example, device identification and/or connector identification information associated with devices 104, 106 and/or connectors 118 may be communicated to the microcontroller 212. Based on the received device and/or connector identification information, the microcontroller 212 and/or a device interconnection mapping engine executing thereon may be configured to determine that the first device 104 is coupled to the second device 106 via connector 118 at specified device interfaces, and that the first device 104 is coupled to the microfluidic pump 206 via a specific interface of the first device 104.

The microcontroller 212 and/or a policy management engine executing thereon may determine whether the specific configuration of devices 104, 106 and/or connector 118 is associated with a policy-managed integrated system. For example, the microcontroller 212 and/or associated policy management engine may compare the configuration with the configurations of one or more known policy-managed integrated systems. If the specific configuration is not associated with a policy-managed integrated system, the devices 104, 106 may be allowed to operate. If the specific configuration is, associated with a policy-managed integrated system, however, the operation of devices 104, 106 may be controlled in accordance with one or more policy control actions. For example, the microcontroller 212 may disallow operation of the integrated systems of devices 104, 106 by not issuing control instructions to the microfluidic pump 206 and/or devices 104, 106. In another example, the microcontroller 212 may allow operation of the integrated system of devices 104, 106, but may do some in some limited way. For example, the microfluidic pump 206 and/or devices 104, 106 may only be operated by the microcontroller 212 under certain thresholds.

In certain embodiments, the information identifying the associated devices 104, 106 stored by the device ID modules 402, 404 and/or information identifying associated connectors 118 may be electronically signed by a trusted authority to provide a measure of confidence in the accuracy of the associated information. Upon receipt of the information, the microcontroller 212 may verify the associated electronic signatures. If the electronic signatures are successfully verified, it may be determined that the received information may be trusted and associated policy may be applied. If the electronic signatures are not successfully verified, it may be determined that the received information is not trusted, and operation of the integrated system may be prevented.

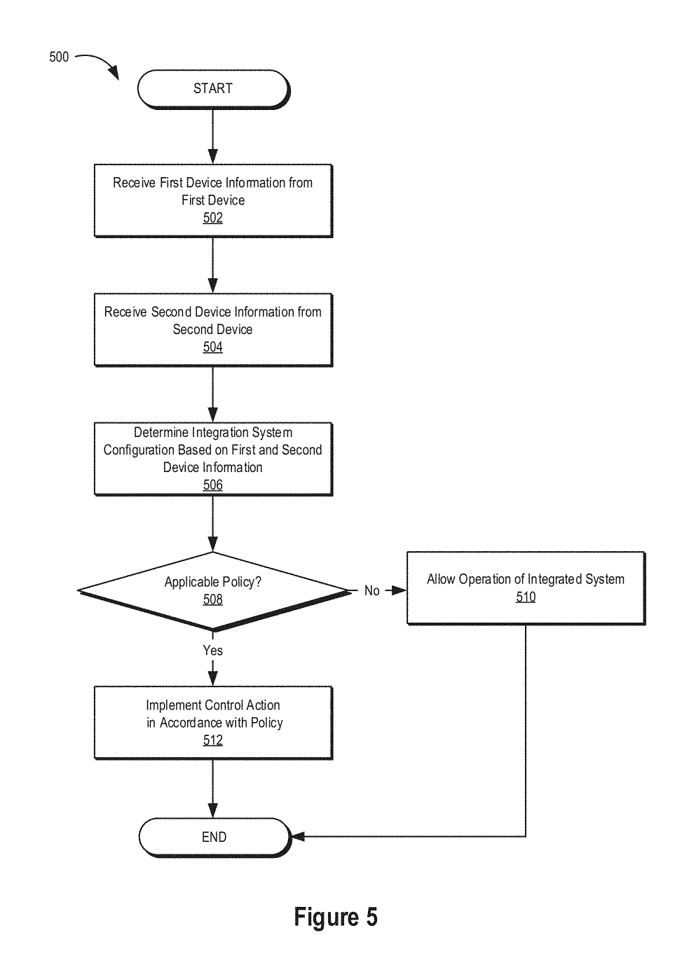

FIG. 5 illustrates a flow chart of an exemplary method 500 of enforcing policy using a device integration platform consistent with embodiments disclosed herein. The illustrated method 500 may be implemented in a variety of ways, including using software, firmware, hardware, and/or any combination thereof. In certain embodiments, various aspects of the method 500 may be implemented by one or more systems associated with a device integration platform consistent with embodiments disclosed herein. Certain embodiments of the method 500 may allow for enforcement of policy in connection with the interconnection and/or operation of LOC devices to ensure that the devices interconnect and/or operate in a permitted and/or otherwise safe manner.

At 502, first device information may be received from a first device of a plurality of devices included on the device integration platform. At 504, second device information may be received from a second device of the plurality of devices included on the device integration platform. In some embodiments, the first and/or second devices may comprise microfluidic devices, optical devices, electrical devices, and/or any combination of the same.

The device information received at 502 and 504 may comprise a variety of types of information. In some embodiments, the information may uniquely identify associated devices (e.g., a serial number or the like). In further embodiments, the information may provide an indication of a type, a model, and/or a function of an associated device.

At 506, an integrated system configuration associated with the configuration of the first device and the second device may be determined based on the device information received at 502 and 504. For example, an interconnection mapping engine may determine that the first device is coupled to the second device at certain interfaces and/or in a particular manner. In this way, the integrated system configuration may describe a configuration of an integrated system comprising the first and second devices on the device integration platform. In some embodiments, the integrated system configuration may further be determined based on information received from and/or otherwise associated with one or more connectors interconnecting various devices on the device integration platform.

Based on the integrated system configuration, it may be determined whether the configuration of the first device and the second device is associated with a managed system policy at 508. If not, the method 500 may proceed to 510 and the operation of the integrated system comprising the first device and the second device may be allowed to proceed. If the configuration of the first device and the second device is associated with a managed system policy, however, the method may proceed to 512.

At 512, at least one control action specified by the managed system policy identified at 508 may be implemented. In some embodiments, the at least one control action may relate to an operation of at least one of the first device and the second device. The at least one control action may comprise, without limitation, one or more of disallowing operation of at least one of the first device and the second device, operating at least one of the first device and the second device below one or more specified thresholds, controlling the operation of at least one third device associated with the device integration platform coupled to at least one of the first device and the second device (e.g., a microfluidic pump, and optical source, and electrical power source, etc.) by, for example, disallowing operation of the third device and/or restricting the operation of the third device under specified thresholds, and/or the like.

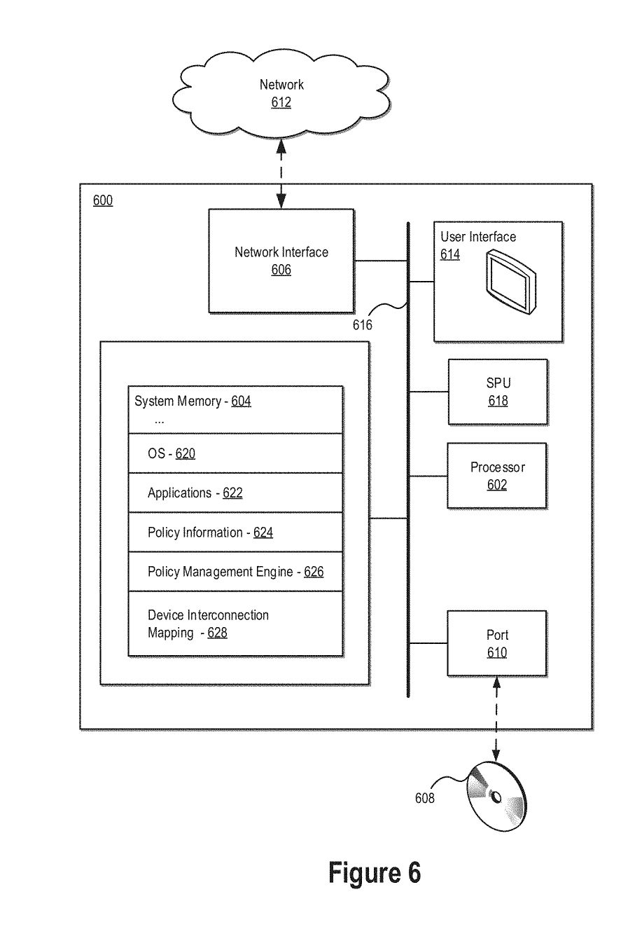

FIG. 6 illustrates an exemplary system 600 that may be used to implement embodiments of the systems and methods of the present disclosure. Certain elements associated with the illustrated exemplary system 600 may be included in a device integration platform and/or an associated microcontroller or other control system, and/or any other system configured to implement embodiments of the disclosed systems and methods.

As illustrated in FIG. 6, the system 600 may include: a processing unit 602; system memory 604, which may include high speed random access memory (“RAM”), non-volatile memory (“ROM”), and/or one or more bulk non-volatile non-transitory computer-readable storage mediums (e.g., a hard disk, flash memory, etc.) for storing programs and other data for use and execution by the processing unit 602; a port 610 for interfacing with removable memory 608 that may include one or more diskettes, and/or other non-transitory computer-readable storage mediums (e.g., flash memory, thumb drives, USB dongles, compact discs, optical storage mediums, DVDs, etc.); a network interface 606 for communicating with other systems via one or more network connections 612 using one or more communication technologies; a user interface 614 that may include a display and/or one or more input/output devices such as, for example, a touchscreen, a keyboard, a mouse, a track pad, and the like; and one or more busses 616 for communicatively coupling the elements of the system.

In some embodiments, the system 600 may, alternatively or in addition, include an SPU 618 that is protected from tampering by a user of the system 600 or other entities by utilizing secure physical and/or virtual security techniques. An SPU 618 can help enhance the security of sensitive operations such as personal information management, trusted credential, signature, and/or key management, privacy, condition, and/or policy management, and other aspects of the systems and methods disclosed herein. In certain embodiments, the SPU 618 may operate in a logically secure processing domain and be configured to protect and operate on secret information, as described herein. In some embodiments, the SPU 618 may include internal memory storing executable instructions or programs configured to enable the SPU 618 to perform secure operations.

The operation of the system 600 may be generally controlled by a processing unit 602 and/or an SPU 618 operating by executing software instructions and programs stored in the system memory 604 (and/or other computer-readable media, such as removable memory). The system memory 604 may store a variety of executable programs or modules for controlling the operation of the system. For example, the system memory 406 may include an operating system (“OS”) 620 that may manage and coordinate, at least in part, system hardware resources and provide for common services for execution of various applications 622. The system memory 604 may further include, without limitation, communication software configured to enable in part communication with and by the system; one or more applications 622; policy information 624; a policy management engine 626; a device interconnection mapping engine 628; and/or any other information, modules, and/or applications configured to implement embodiments of the systems and methods disclosed herein.

The systems and methods disclosed herein are not inherently related to any particular computer, device, service, or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network. Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, an optical storage medium, flash memory, integrated circuits, or any other non-transitory digital processing apparatus memory device.

Although the foregoing has been described in some detail for purposes of clarity, it will be apparent that certain changes and modifications may be made without departing from the principles thereof. It should be noted that there are many alternative ways of implementing both the systems and methods described herein. Accordingly, the present embodiments are to be considered as illustrative and not restrictive, and the invention is not to be limited to the details given herein, but may be modified within the scope and equivalents of the appended claims.

What is claimed is:

1. A method for managing the operation of a plurality of devices included on a device integration platform performed by a control system comprising a processor and a non-transitory computer-readable medium storing instructions that, when executed by the processor, cause the control system to perform the method, the method comprising:
receiving, from a first device of the plurality of devices included on the device integration platform, first device information;
receiving, from a second device of the plurality of devices included on the device integration platform, second device information;
determining, based on the first device information and the second device information, an integrated system configuration associated with the first device and the second device;
identifying, based on the integrated system configuration, a managed system policy; and
implementing at least one control action in connection with the operation of at least one of the first device and the second device based on the identified managed system policy.

2. The method of claim 1, wherein at least one of the first device and the second device comprises a microfluidic device.

3. The method of claim 1, wherein at least one of the first device and the second device comprises an optical device.

4. The method of claim 1, wherein at least one of the first device and the second device comprises an electrical device.

5. The method of claim 1, wherein the first device information comprises at least one of a serial number of the first device, a model number of the first device, and a description of a function of the first device.

6. The method of claim 1, wherein the second device information comprises at least one of a serial number of the second device, a model number of the second device, and a description of a function of the second device.

7. The method of claim 1, wherein the integrated system configuration comprises a description of the configuration of the first device and the second device on the device integration platform.

8. The method of claim 1, wherein implementing the at least one control action comprises disallowing operation of at least one of the first device and the second device.

9. The method of claim 1, wherein implementing the at least one control action comprises operating at least one of the first device and the second device below one or more specified thresholds.

10. The method of claim 1, wherein implementing the at least one control action comprises controlling the operation of at least one third device associated with the device integration platform coupled to at least one of the first device and the second device.

11. The method of claim 10, wherein the at least one third device comprises a microfluidic pump.

12. The method of claim 10, wherein the at least one third device comprises an optical source.

13. The method of claim 10, wherein the at least one third device comprises an electrical power source.

14. The method of claim 10, wherein controlling the operation of the at least one third device comprises disallowing operation of the at least one third device.

15. The method of claim 10, wherein implementing the at least one control action comprises operating the at least one third device below one or more specified thresholds.

16. The method of claim 1, wherein the method further comprises:
receiving, from a connector interconnecting an interface of the first device with an interface of the second device, connector information.

17. The method of claim 16, wherein determining the integrated system configuration is further based on the connector information.

18. The method of claim 1, wherein the method further comprises verifying an electronic signature associated with at least one of the first device information and the second device information.
